(19) United States
(12) Patent Application Publication
(10) Pub. No.: US 2023/0379961 A1
(43) Pub. Date: Nov. 23, 2023

(54) PRIORITY HANDLING FOR APERIODIC CSI ON PUCCH

(71) Applicant: Telefonaktiebolaget LM Ericsson (publ), Stockholm (SE)

(72) Inventors: Siva Muruganathan, Stittsville (CA); Yufei Blankenship, Kildeer, IL (US); Shiwei Gao, Nepean (CA); Sorour Falahati, Stockholm (SE); Robert Mark Harrison, Grapevine, TX (US); Jonas Fröberg Olsson, Ljungsbro (SE); Zhipeng Lin, Nanjing (CN)

(21) Appl. No.: 18/031,363

(22) PCT Filed: Oct. 12, 2021
(86) PCT No.: PCT/IB2021/059364

§ 371 Date: Apr. 12, 2023

(30) Foreign Application Priority Data
Oct. 12, 2020 (WO) PCT/CN2020/120311

(51) Int. Cl. H04W 72/563; H04W 72/20; H04W 24/10

(52) U.S. Cl. CPC H04W 72/563; H04W 72/20; H04W 24/10

(57) ABSTRACT

Systems and methods for priority handling for Aperiodic-Channel State Information (A-CSI) on Physical Uplink Control Channel (PUCCH) are provided. In some embodiments, a method performed by a wireless device includes: determining a first priority level of a first Uplink Control Information (UCI) (A-CSI on PUCCH triggered by a downlink related DCI); determining a second priority level of a second UCI; and/or performing a priority level handling action based on a comparison of the first priority level and the second priority level. In some embodiments, performing the priority level handling action includes: multiplexing the UCIs and transmitting them together; transmitting the first UCI and the second UCI separately; and dropping one of the UCIs and transmitting the other. In this way, proper priority levels can be determined for A-CSI on PUCCH when it collides with other types of UCI.

### RELATED APPLICATIONS

This application claims the benefit of PCT patent application Ser. No. PCT/CN2020/120311, filed Oct. 12, 2020, the disclosure of which is hereby incorporated herein by reference in its entirety.

### TECHNICAL FIELD

The present disclosure relates to reporting Channel State Information.

### BACKGROUND

NR uses CP-OFDM (Cyclic Prefix Orthogonal Frequency Division Multiplexing) in both downlink (DL) (i.e., from a network node, gNB, or base station, to a user equipment or UE) and uplink (UL) (i.e., from UE to gNB). Discrete Fourier Transform spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δƒ=15 kHz, there is only one slot per subframe, and each slot consists of 14 OFDM symbols.

Data scheduling in NR is typically in slot basis, an example is shown in FIG. 1 with a 14-symbol slot, where the first two symbols contain physical downlink control channel (PDCCH) and the rest contains physical shared data channel, either PDSCH(physical downlink shared channel) or PUSCH (physical uplink shared channel).

Different subcarrier spacing values are supported in NR. The supported subcarrier spacing values (also referred to as different numerologies) are given by Δƒ=(15×2^{μ}) kHz where μ∈{0,1,2,3,4}. Δƒ=15 kHz is the basic subcarrier spacing. The slot durations at different subcarrier spacings is given by

$$\frac{1}{{2}^{μ}} ms .$$

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink (DL) and uplink (UL) data transmissions can be either dynamically or semi-persistently scheduled by a gNB. In case of dynamic scheduling, the gNB may transmit in a downlink slot downlink control information (DCI) to a UE on PDCCH (Physical Downlink Control Channel) about data carried on a physical downlink shared channel (PDSCH) to the UE and/or data on a physical uplink shared channel (PUSCH) to be transmitted by the UE. In case of semi-persistent scheduling, periodic data transmission in certain slots can be configured and activated/deactivated.

For each transport block data transmitted over PDSCH, a HARQ ACK is sent in a UL Physical Uplink Control Channel (PUCCH) on whether it is decoded successfully or not. An ACK is sent if it is decoded successfully and a NACK is sent otherwise.

PUCCH can also carry other UL control information (UCI) such as scheduling request (SR) and DL Channel State Information (CSI).

There are three DCI formats defined for scheduling PDSCH in NR, i.e., DCI format 1_0 and DCI format 1_1 which were introduced in NR Rel-15, and DCI format 1_2 which was introduced in NR Rel-16. DCI format 1_0 has a smaller size than DCI 1_1 and can be used when a UE is not fully connected to the network while DCI format 1_1 can be used for scheduling MIMO (Multiple-Input-Multiple-Output) transmissions with multiple MIMO layers.

In NR Rel-16, DCI format 1_2 was introduced for downlink scheduling. One of the main motivations for having the new DCI format is to be able to configure a very small DCI size which can provide some reliability improvement without losing much flexibility. The main design target of the new DCI format is thus to have DCI with configurable sizes for some fields with a minimum DCI size targeting a reduction of 10-16 bits relative to Rel-15 DCI format 1_0.

NR HARQ ACK/NACK feedback over PUCCH

When receiving a PDSCH in the downlink from a serving gNB at slot n, a UE feeds back a HARQ ACK at slot n+k over a PUCCH (Physical Uplink Control Channel) resource in the uplink to the gNB if the PDSCH is decoded successfully, otherwise, the UE sends a HARQ ACK/NACK at slot n+k to the gNB to indicate that the PDSCH is not decoded successfully. If two transport blocks (TBs) are carried by the PDSCH, then a HARQ ACK/NACK is reported for each TB.

For DCI format 1_0, k is indicated by a 3-bit PDSCH-to-HARQ-timing-indicator field. For DCI formats 1_1 and 1_2, k is indicated either by a 0-3 bit PDSCH-to-HARQ-timing-indicator field, if present, or by higher layer configuration through Radio Resource Control (RRC) signaling. Separate RRC configuration of PDSCH to HARQ-Ack timing are used for DCI formats 1_1 and 1_2.

For DCI format 1_1, if code block group (CBG) transmission is configured, a HARQ ACK/NACK for each CBG in a TB is reported instead.

In case of carrier aggregation (CA) with multiple carriers and/or TDD operation, multiple aggregated HARQ ACK/NACK bits need to be sent in a single PUCCH.

In NR, up to four PUCCH resource sets can be configured to a UE. A PUCCH resource set with pucch-ResourceSetId=0 can have up to 32 PUCCH resources while for PUCCH resource sets with pucch-ResourceSetId=1 to 3, each set can have up to 8 PUCCH resources. A UE determines the PUCCH resource set in a slot based on the number of aggregated UCI (Uplink Control Information) bits to be sent in the slot. The UCI bits consists of HARQ ACK/NACK, scheduling request (SR), and channel state information (CSI) bits.

A 3 bits PUCCH resource indicator (PRI) field in DCI maps to a PUCCH resource in a set of PUCCH resources with a maximum of eight PUCCH resources. For the first set of PUCCH resources with pucch-ResourceSetId =0 and when the number of PUCCH resources, R^{PUCCH}, in the set is larger than eight, the UE determines a PUCCH resource with index r^{PUCCH}, 0≤r_{PUCCH}≤R_{PUCCH}−1, for carrying HARQ-ACK information in response to detecting a last DCI format 1_0 or DCI format 1_1 in a PDCCH reception, among DCI formats 1_0 or DCI formats 1_1 the UE received with a value of the PDSCH-to-HARQ_feedback timing indicator field indicating a same slot for the PUCCH transmission, as

$${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot \\ ⌊ \frac{{R}_{PUCCH}}{8} ⌋ + {R}_{PUCCH} mod 8\end{matrix} & if {Δ}_{PRI} \geq {R}_{PUCCH} mod 8\end{matrix} \}$$

where N_{CCB,p} is a number of CCEs in CORESETₚ of the PDCCH reception for the DCI format 1_0 or DCI format 1_1 as described in Subclause 10.1 of 3GPP TS38.213 v15.4.0, n_{CCE,p} is the index of a first CCE for the PDCCH reception, and Δ_{PRI} is a value of the PUCCH resource indicator field in the DCI format 1_0 or DCI format 1_1.

PUCCH Formats: Five PUCCH formats are defined in NR, i.e., PUCCH formats 0 to 4. UE transmits UCI in a PUCCH using
PUCCH format 0 if
   the transmission is over 1 symbol or two symbols,
   the number of HARQ-ACK information bits with positive or negative SR (HARQ-ACK/SR bits) is 1 or 2
PUCCH format 1 if
   the transmission is over 4 or more symbols,
   the number of HARQ-ACK/SR bits is 1 or 2
PUCCH format 2 if
   the transmission is over 1 symbol or two symbols,
   the number of UCI bits is more than 2
PUCCH format 3 if
   the transmission is over 4 or more symbols,
   the number of UCI bits is more than 2,
PUCCH format 4 if
   the transmission is over 4 or more symbols,
   the number of UCI bits is more than 2.

PUCCH formats 0 and 2 use one or two OFDM symbols while PUCCH formats 1,3 and 4 can span from 4 to 14 symbols. Thus, PUCCH format 0 and 2 are referred to as short PUCCH while PUCCH formats 1, 3, and 4 as long PUCCH.

Short PUCCH formats: A PUCCH format 0 resource can be one or two OFDM symbols within a slot in time domain and one RB in frequency domain. UCI is used to select a cyclic shift of a computer-generated length 12 base sequence which is mapped to the RB. The starting symbol and the starting RB are configured by RRC. In case of two symbols are configured, the UCI bits are repeated in 2 consecutive symbols.

A PUCCH format 2 resource can be one or two OFDM symbols within a slot in time domain and one or more RB in frequency domain. UCI in PUCCH Format 2 is encoded with RM (Reed-Muller) codes (≤11bits UCI+CRC) or Polar codes (>11 bit UCI+CRC) and scrambled. In case of two symbols are configured, UCI is encoded and mapped across two consecutive symbols.

Intra-slot frequency hopping (FH) may be enabled in case of two symbols are configured for PUCCH formats 0 and 2. If FH is enabled, the starting PRB in the second symbol is configured by RRC. Cyclic shift hopping is used when two symbols are configured such that different cyclic shifts are used in the two symbols.

Long PUCCH formats: A PUCCH format 1 resource is 4-14 symbols long and 1 PRB wide per hop. A computer-generated length 12 base sequence is modulated with UCI and weighted with time-domain OCC code. Frequency-hopping with one hop within the active UL BWP for the UE is supported and can be enabled/disabled by RRC. Base sequence hopping across hops is enabled in case of FH and across slots in case of no FH.

A PUCCH Format 3 resource is four—fourteen symbols long and one or multiple PRB wide per hop. UCI in PUCCH Format 3 is encoded with RM (Reed-Muller) codes (11 bit UCI+CRC) or Polar codes (>11 bit UCI+CRC) and scrambled.

A PUCCH Format 4 resource is also four—fourteen symbols long but one PRB wide per hop. It has a similar structure as PUCCH format 3 but can be used for multi-UE multiplexing.

For PUCCH formats 1, 3, or 4, a UE can be configured a number of slots, N^{repeat}_{PUCCH}, for repetitions of a PUCCH transmission by respective nrofSlots. For N^{repeat}_{PUCCH} >1,
the UE repeats the PUCCH transmission with the UCI over N^{repeat}_{PUCCH} slots
a PUCCH transmission in each of the N^{repeat}_{PUCCH} slots has a same number of consecutive symbols,
a PUCCH transmission in each of the N^{repeat}_{PUCCH} slots has a same first symbol,
if the UE is configured to perform frequency hopping for PUCCH transmissions across different slots
   the UE performs frequency hopping per slot
   the UE transmits the PUCCH starting from a first PRB in slots with even number and starting from the second PRB in slots with odd number. The slot indicated to the UE for the first PUCCH transmission has number 0 and each subsequent slot until the UE transmits the PUCCH in N^{repeat}_{PUCCH} slots is counted regardless of whether or not the UE transmits the PUCCH in the slot
   the UE does not expect to be configured to perform frequency hopping for a PUCCH transmission within a slot
If the UE is not configured to perform frequency hopping for PUCCH transmissions across different slots and if the UE is configured to perform frequency hopping for PUCCH transmissions within a slot, the frequency hopping pattern between the first PRB and the second PRB is same within each slot

Sub-slot based PUCCH transmission: In NR Rel-16, sub-slot based PUCCH transmission was introduced so that HARQ-Ack associated with different type of traffic can be multiplexed in a same UL slot, each transmitted in a different sub-slot. The sub-slot size can be higher layer configured to either two symbols or seven symbols. In case of sub-slot configuration each with two symbols, there are 7 sub-slots in a slot. In case of sub-slot with seven symbols, there are two sub-slots in a slot.

HARQ A/N enhancement for URLLC in NR Rel-16: In NR Rel 16, a higher priority may be assigned to PDSCHs carrying URLLC (Ultra-reliable Low latency) traffic and indicated in DCIs scheduling the PDSCHs. HARQ Ack/Nack information for PDSCHs with higher priority is transmitted separately from HARQ A/N information for other PDSCHs. This allows HARQ A/N for URLLC traffic be transmitted early in different PUCCH resources and more reliably.

Furthermore, in NR Rel-16, it has been agreed that at least one sub-slot configuration for PUCCH can be UE-specifically configured and that multiple HARQ Ack/Nack transmissions per slot are possible. The sub-slot configuration supports periodicities of two symbols (i.e., seven 2-symbol PUCCH occasions per slot) and seven symbols (i.e., two 7-symbol PUCCH occasions per slot). One of the reasons for introducing these sub-slot configurations in NR Rel-16 is to enable the possibility for multiple opportunities of HARQ Ack/Nack transmissions within a slot without needing to configure several PUCCH resources. For example, in Rel-16, a UE running URLLC service may be configured with a possibility of receiving PDCCH in every second OFDM symbol e.g., symbol 0, 2, 4, . . . , 12 and be configured with a PUCCH resource with sub-slot configuration seven 2-symbol sub-slots within a slot for HARQ-ACK transmission also in every second symbol, e.g., 1, 3, . . . , 13. For a Rel-16 UE configured with sub-slots slots for PUCCH transmission, the PDSCH-to-HARQ feedback timing indicator field in DCI indicates the timing offset in terms of sub-slots instead of slots.

CSI framework in NR: In NR, a UE can be configured with multiple CSI reporting settings (each represented by a higher layer parameter CSI-ReportConfig with an associated identity ReportConfiglD) and multiple CSI resource settings (each represented by a higher layer parameter CSI-ResourceConfig with an associated identity CSI-ResourceConfigld). Each CSI resource setting can contain multiple CSI resource sets (each represented by a higher layer parameter NZP-CSI-RS-ResourceSet with an associated identity NZP-CSI-RS-ResourceSetld for channel measurement or by a higher layer parameter CSI-IM-ResourceSet with an associated identity CSI-IM-ResourceSetld for interference measurement), and each NZP CSI-RS resource set for channel measurement can contain up to eight NZP CSI-RS resources. For each CSI reporting setting, a UE feeds back a set of CSIs, which may include one or more of a CRI (CSI-RS resource indicator), a RI, a PMI and a CQI per CW, depending on the configured report quantity.

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band.

In each CSI reporting setting, it contains at least the following information:
A CSI resource setting for channel measurement based on NZP CSI-RS resources (represented by a higher layer parameter resourcesForChanne/Measurement)
A CSI resource setting for interference measurement based on CSI-IM resources (represented by a higher layer parameter csi-IM-ResourcesForInterference)
Optionally, a CSI resource setting for interference measurement based on NZP CSI-RS resources (represented by a higher layer parameter nzp-CSI-RS-ResourcesForInteference)
Time-domain behavior, i.e., periodic, semi-persistent, or aperiodic reporting (represented by a higher layer parameter reportConfigType)
Frequency granularity, i.e., wideband or subband
CSI parameters to be reported such as RI, PMI, CQI, L1-RSRP/L1_SINR and CRI in case of multiple NZP CSI-RS resources in a resource set is used for channel measurement (represented by a higher layer parameter reportQuantity, such as ‘cri-RI-PMI-CQI’‘cri-RSRP’, or ‘ssb-Index-RSRP’)
Codebook types, i.e., type I or II if reported, and codebook subset restriction
Measurement restriction

For periodic and semi-static CSI reporting, only one NZP CSI-RS resource set can be configured for channel measurement and one CSI-IM resource set for interference measurement. For aperiodic CSI reporting, a CSI resource setting for channel measurement can contain more than one NZP CSI-RS resource set for channel measurement. If the CSI resource setting for channel measurement contains multiple NZP CSI-RS resource sets for aperiodic CSI report, only one NZP CSI-RS resource set can be selected and indicated to a UE. For aperiodic CSI reporting, a list of trigger states is configured (given by the higher layer parameters CSI-AperiodicTriggerStateList). Each trigger state in CSI-AperiodicTriggerStateListcontains a list of associated CSI-ReportConfigs indicating the Resource Set IDs for channel and optionally for interference. For a UE configured with the higher layer parameter CSI-AperiodicTriggerStateList, if a Resource Setting linked to a CSI-ReportConfig has multiple aperiodic resource sets, only one of the aperiodic CSI-RS resource sets from the Resource Setting is associated with the trigger state, and the UE is higher layer configured per trigger state per Resource Setting to select the one NZP CSI-RS resource set from the Resource Setting.

When more than one NZP CSI-RS resources are contained in the selected NZP CSI-RS resource set for channel measurement, a CSI-RS resource indicator (CRI) is reported by the UE to indicate to the gNB about the one selected NZP CSI-RS resource in the resource set, together with RI, PMI and CQI associated with the selected NZP CSI-RS resource. This type of CSI assumes that a PDSCH is transmitted from a single transmission point (TRP) and the CSI is also referred to as single TRP CSI.

Aperiodic CSI feedback on PUCCH: In current NR specifications, aperiodic CSI feedback can only be carried via PUSCH. Furthermore, in current NR specifications, the aperiodic CSI feedback can only be trigged via uplink related DCI (i.e., DCI formats 0_1 and 0_2). However, this is not flexible in a scenario that is downlink heavy where the gNB would schedule the UE with PDSCH via downlink related DCI (i.e., DCI formats 1_1 and 1_2) more often than scheduling the UE with PUSCH via uplink related DCI. To improve network scheduling flexibility, it is beneficial to support triggering of aperiodic CSI via downlink related DCI. In this case, the aperiodic CSI will be carried on PUCCH.

In U.S. Patent Application Publication 2020/0295903 “PUCCH RESOURCE INDICATION FOR CSI AND HARQ FEEDBACK” (hereinafter referred to as [1]), a solution is proposed where a CSI request field is introduced in downlink related DCI which would be used to trigger aperiodic CSI reports on PUCCH. Furthermore, the solution in [1] proposes to reuse the existing PUCCH resource indication field in downlink related DCI to indicate the PUCCH resource for aperiodic CSI feedback. Depending on if the downlink related DCI carries a downlink grant for PDSCH and/or a CSI request, the PUCCH resource indication field can be interpreted differently according to the solution in [1].

In [1], one solution is proposed where the Aperiodic CSI and the HARQ-ACK corresponding to the PDSCH being scheduled by the downlink related DCI are multiplexed and sent on the same PUCCH resource. To address the cases where the PDSCH processing time and the processing time for aperiodic CSI are different, another solution is proposed in [1] where the Aperiodic CSI and HARQ-ACK corresponding to the PDSCH being scheduled by the downlink related DCI are transmitted in different slots.

If Aperiodic CSI reporting on PUCCH is introduced in NR, then how to handle collisions (i.e., overlaps) with other types of UCI need to be defined. Then, how to handle collisions is an open problem which needs to be solved.

### SUMMARY

Systems and methods for priority handling for Aperiodic-Channel State Information (A-CSI) on Physical Uplink Control Channel (PUCCH) are provided. In some embodiments, a method performed by a wireless device for priority level handling includes one or more of: determining a first priority level of a first Uplink Control Information (UCI) where the first UCI is an A-CSI on PUCCH triggered by a downlink related Downlink Control Information (DCI); determining a second priority level of a second UCI; and performing a priority level handling action based on a comparison of the first priority level and the second priority level. In some embodiments, the second UCI includes: one or more Hybrid Automatic Repeat Request (HARQ) ACK/NACKs; a Scheduling Request (SR); an aperiodic CSI report to be carried on Physical Uplink Shared Channel (PUSCH); a semi-persistent CSI report to be carried on PUCCH; a periodic CSI report to be carried on PUCCH; and/or a second A-CSI report to be carried on PUCCH. In some embodiments, performing the priority level handling action includes: multiplexing the first UCI and the second UCI and transmitting them together in one uplink resource; transmitting the first UCI and the second UCI separately in different uplink resources; and dropping one of the first UCI or the second UCI and transmitting only one of the UCIs in one uplink resource. In this way, proper priority levels can be determined for A-CSI on PUCCH when it collides with other types of UCI. Depending on the priority levels, A-CSI on PUCCH can be multiplexed with other UCI, prioritized over other UCI, or deprioritized (i.e., dropped) when compared to other UCI. In some embodiments, the uplink resource above is a PUCCH resource. In some other embodiments, the uplink resource is an allocated PUSCH resource.

In this disclosure, priority handling of aperiodic CSI reporting on PUCCH when it collides with other types of UCI. Rules for how to determine the priority level of aperiodic CSI reporting on PUCCH are defined. Furthermore, actions such as multiplexing the aperiodic CSI report with other CSI on PUCCH, dropping/prioritizing the aperiodic CSI reporting on PUCCH based on priority level comparisons is defined.

With the proposed solution proper priority levels can be determined for A-CSI on PUCCH when it collides with other types of UCI. Depending on the priority levels, A-CSI on PUCCH can be multiplexed with other UCI, prioritized over other UCI, or deprioritized (i.e., dropped) when compared to other UCI.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates data scheduling in NR in a slot basis;

FIG. 2 illustrates the basic NR physical time-frequency resource grid;

FIG. 3 illustrates an example of one and two symbol short PUCCH without FH;

FIG. 4 illustrates an example 14-symbol and 7-symbol long PUCCH with intra-slot FH enabled;

FIG. 5 illustrates an example 14-symbol and 7-symbol long PUCCH with intra-slot FH disabled;

FIG. 6 illustrates an example of PUCCH repetition in two slots with (a) inter-slot FH enabled and (b) inter-slot FH disabled while intra-slot FH enabled;

FIG. 7 illustrates one example of a cellular communications system according to some embodiments of the present disclosure;

FIG. 8 illustrates a method performed by a wireless device for priority level handling, according to some other embodiments of the present disclosure;

FIG. 9 illustrates a method performed by a base station for priority level handling, according to some other embodiments of the present disclosure;

FIG. 10 illustrates an example where the A-CSI and HARQ-ACK share the same unit (slot vs sub-slot) for transmission, according to some embodiments of the present disclosure;

FIG. 11 illustrates an example where prioritization can be applied to the overlapping A-CSI and HARQ-ACK, where the higher-priority UCI (either A-CSI or HARQ-ACK) is kept while the lower-priority UCI (either HARQ-ACK or A-CSI) is dropped, according to some embodiments of the present disclosure;

FIG. 12 is a schematic block diagram of a radio access node according to some embodiments of the present disclosure;

FIG. 13 is a schematic block diagram that illustrates a virtualized embodiment of the radio access node of FIG. 12 according to some embodiments of the present disclosure;

FIG. 14 is a schematic block diagram of the radio access node of FIG. 12 according to some other embodiments of the present disclosure;

FIG. 15 is a schematic block diagram of a User Equipment device (UE) according to some embodiments of the present disclosure;

FIG. 16 is a schematic block diagram of the UE of FIG. 15 according to some other embodiments of the present disclosure;

FIG. 17 illustrates a telecommunication network connected via an intermediate network to a host computer in accordance with some embodiments of the present disclosure;

FIG. 18 is a generalized block diagram of a host computer communicating via a base station with a UE over a partially wireless connection in accordance with some embodiments of the present disclosure;

FIG. 19 is a flowchart illustrating a method implemented in a communication system in accordance with one embodiment of the present disclosure;

FIG. 20 is a flowchart illustrating a method implemented in a communication system in accordance with one embodiment of the present disclosure;

FIG. 21 is a flowchart illustrating a method implemented in a communication system in accordance with one embodiment of the present disclosure; and

FIG. 22 is a flowchart illustrating a method implemented in a communication system in accordance with one embodiment of the present disclosure.

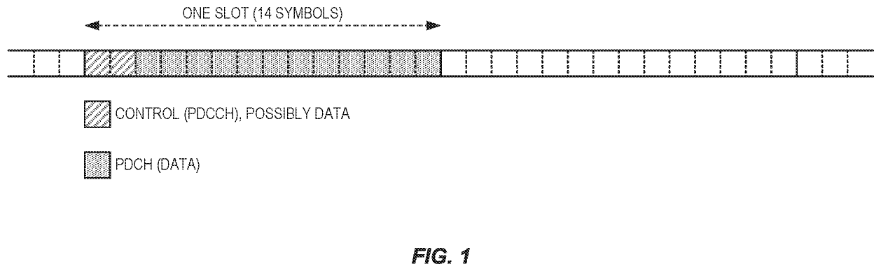

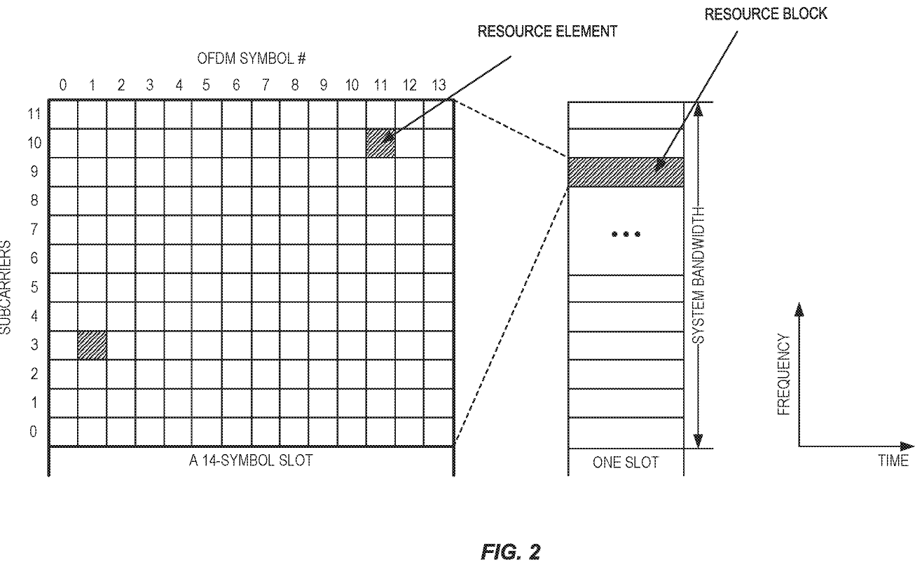

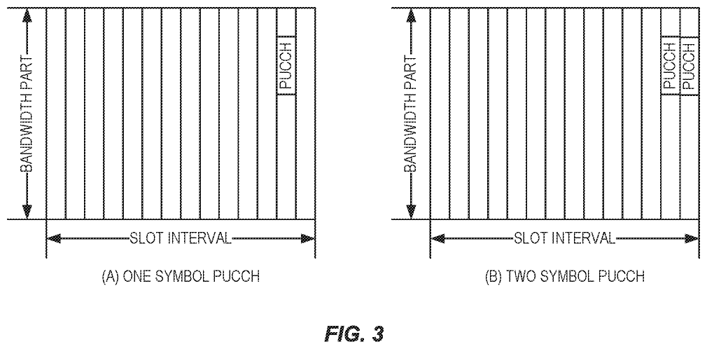

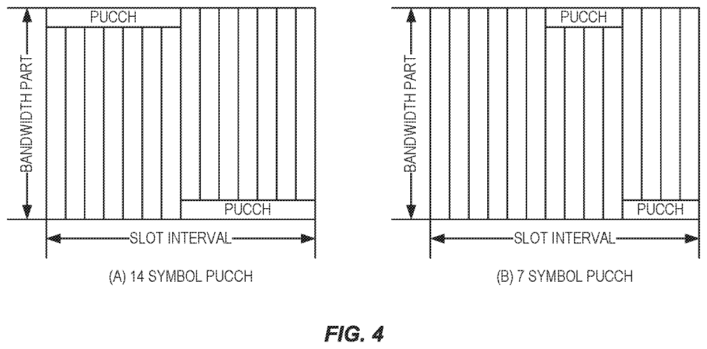

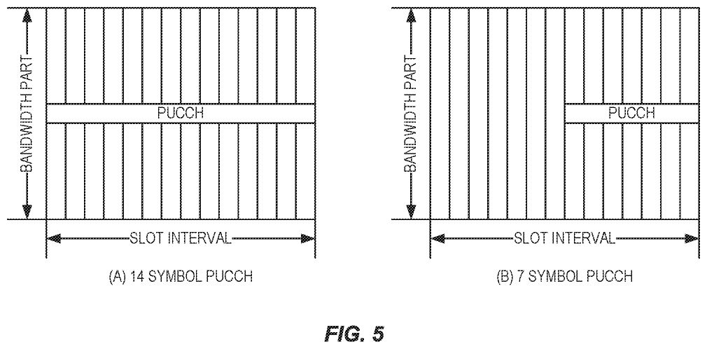

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User αEquipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

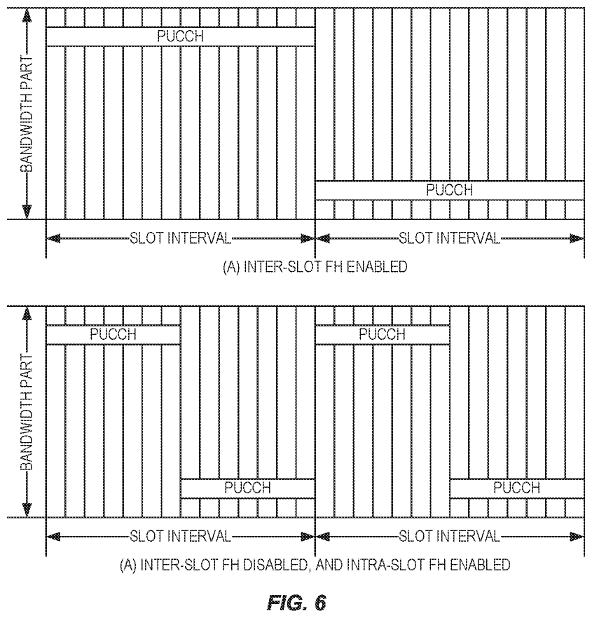

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC). In this example, the RAN includes base stations 702-1 and 702-2, which in the 5GS include NR base stations (gNBs) and optionally next generation eNBs (ng-eNBs) (e.g., LTE RAN nodes connected to the 5GC), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs, but the present disclosure is not limited thereto.

If Aperiodic-Channel State Information (A-CSI) reporting on Physical Uplink Control Channel (PUCCH) is introduced in NR, then how to handle collisions (i.e., overlaps) with other types of UCI need to be defined. Then, how to handle collisions is an open problem which needs to be solved.

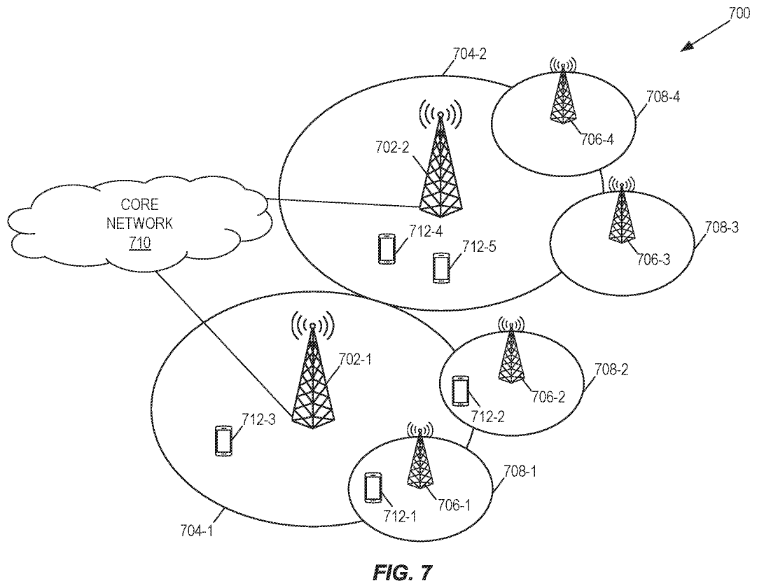

Systems and methods for priority handling for A-CSI on PUCCH are provided. FIG. 8 illustrates a method performed by a wireless device for priority level handling, according to some other embodiments of the present disclosure. In some embodiments, a method performed by a wireless device for priority level handling includes one or more of: determining (step 800) a first priority level of a first Uplink Control Information (UCI) where the first UCI is an A-CSI on PUCCH triggered by a downlink related Downlink Control Information (DCI); determining (step 802) a second priority level of a second UCI; and performing (step 804) a priority level handling action based on a comparison of the first priority level and the second priority level. In some embodiments, the second UCI includes: one or more Hybrid Automatic Repeat Request (HARQ) ACK/NACKs; a Scheduling Request (SR); an aperiodic CSI report to be carried on Physical Uplink Shared Channel (PUSCH); a semi-persistent CSI report to be carried on PUCCH; a periodic CSI report to be carried on PUCCH; and/or a second A-CSI report to be carried on PUCCH. In some embodiments, performing the priority level handling action includes: multiplexing the first UCI and the second UCI and transmitting them together in one uplink resource; transmitting the first UCI and the second UCI separately in different uplink resources; and dropping one of the first UCI or the second UCI and transmitting only one of the UCIs in one uplink resource. In this way, proper priority levels can be determined for A-CSI on PUCCH when it collides with other types of UCI. Depending on the priority levels, A-CSI on PUCCH can be multiplexed with other UCI, prioritized over other UCI, or deprioritized (i.e., dropped) when compared to other UCI.

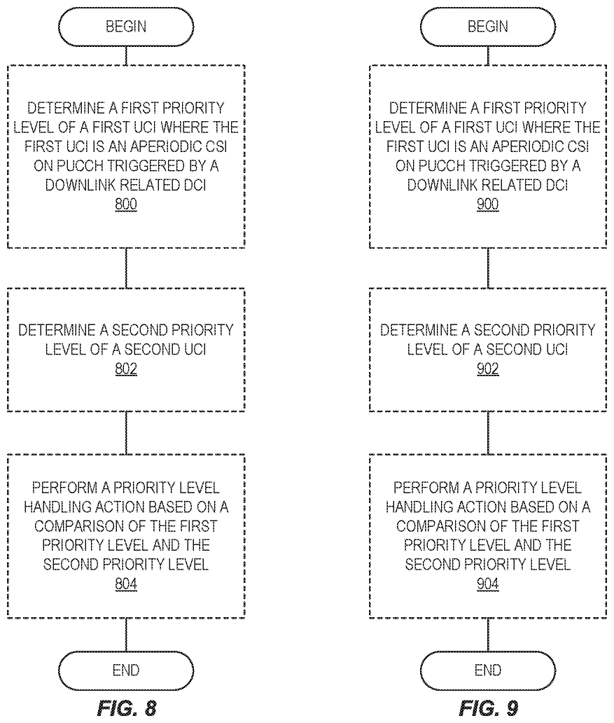

FIG. 9 illustrates a method performed by a base station for priority level handling, according to some other embodiments of the present disclosure. In some embodiments, a method performed by a base station for priority level handling includes one or more of: determining (step 900) a first priority level of a first UCI where the first UCI is an aperiodic CSI on PUCCH triggered by a downlink related DCI; determining (step 902) a second priority level of a second UCI; and performing (step 904) a priority level handling action based on a comparison of the first priority level and the second priority level.

Priority Handling of triggered A-CSI on PUCCH

In NR Rel-16, UCI (SR, HARQ-ACK, CSI) are assigned priority levels before transmission, where the priority level can be ‘0’ for low priority, or ‘1’ for high priority. For A-CSI triggered by DL DCI, there is also a need to determine its priority level to prepare for transmission.

In one embodiment, priority level of the triggered A-CSI on PUCCH is determined by the priority indicator field in the DCI (i.e., DL DCI with formats 1_1 or 1_2) if the priority indicator field is present in the DCI. Otherwise, if the priority indicator field is absent from the DCI, then the A-CSI takes the default priority level of ‘0’. In this case, the triggered A-CSI has the same priority level as the HARQ-ACK which is associated with the same DCI or another DL DCI.

In another embodiment, the triggered A-CSI on PUCCH is assigned a fixed priority level. For example, such A-CSI is always assigned ‘1’ for high priority. Alternatively, such A-CSI is always assigned ‘0’ for low priority. In this case, the triggered A-CSI may have the same, or different, priority level from that of the HARQ-ACK which is associated with the same DCI or another DL DCI.

If the A-CSI to be transmitted on PUCCH and HARQ-ACK associated with the same DCI may overlap in time, their priority levels need to be taken into account when processing them for transmission.

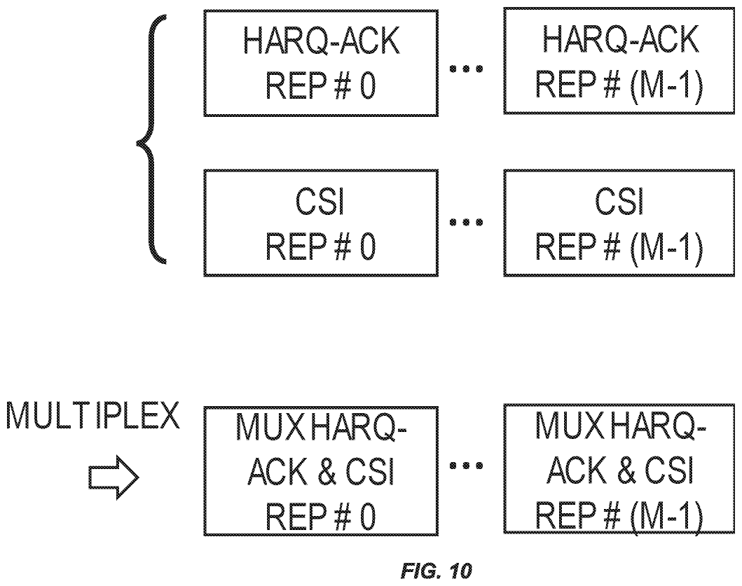

In one embodiment, the overlapping A-CSI and HARQ-ACK are multiplexed for transmission on a same PUCCH. Preferably, the A-CSI and HARQ-ACK share the same unit (slot vs sub-slot) for transmission, and have the same start and end time if repetition is applied. This is illustrated in FIG. 10. Multiplexing is typically applied if A-CSI and the associated HARQ-ACK have the same priority level. On the other hand, for A-CSI and HARQ-ACK of the same DCI, multiplexing may be applied even if they have different priority level. In some embodiments, whether to multiplex A-CSI and HARQ-ACK based on same priority level or multiplexing A-CSI and HARQ-ACK regardless of the priority level may be configured by a higher layer configuration (e.g., RRC) parameter signaled to the UE.

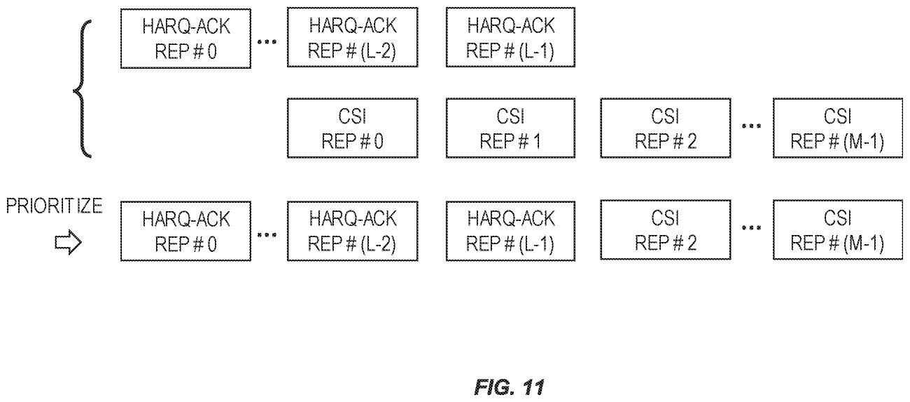

In another embodiment, prioritization can be applied to the overlapping A-CSI and HARQ-ACK, where the higher-priority UCI (either A-CSI or HARQ-ACK) is kept while the lower-priority UCI (either HARQ-ACK or A-CSI) is dropped. This is illustrated in FIG. 11, where the example assumed that HARQ-ACK has high-priority while A-CSI has low-priority. When repetition is applied to A-CSI and/or HARQ-ACK, and they do not start and end simultaneously, the non-overlapping part of the lower-priority UCI can still be kept for transmission, as illustrated in FIG. 11. To avoid the complexity associated with prioritization and multiplexing, the configuration of timing related parameters (e.g., start time, number of repetitions) of A-CSI and HARQ-ACK can be set to avoid any overlap. For example, the start time (e.g., as indicated by k′) of A-CSI has to be later than the end of the associated HARQ-ACK. Alternatively, the start time of A-CSI can be indicated with reference to the end time of HARQ-ACK (including repetition, if any).

In NR, priority is also defined among different CSI reports. A CSI report is associated with a priority value Pri_{iCSI} (y, k, c, s)=2·N_{cells}·Mₛ·y+N_{cells}·Mₛ·k+Mₛ·c+s where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells,
s is the reportConfigID and Mₛ is the value of the higher layer parameter maxNrofCSI-ReportConfigurations.

A first CSI report is said to have priority over second CSI report if the associated Pri_{iCSI} (y, k, c, s) value is lower for the first report than for the second report.

When A-CSI on PUCCH is introduced, a priority can be similarly defined. In one embodiment, A-CSI on PUCCH is treated the same as A-CSI on PUSCH, i.e., y=0. In another embodiment, a different scaling factor y may be assigned to A-CSI on PUCCH, e.g., y=1.5, i.e., lower than A-CSI on PUSCH but higher than others.

In a further embodiment, A-CSI on PUCCH has a higher priority than A-CSI on PUSCH, e.g., y<0.

For example, when a UE is configured to transmit a first and a second CSI report with y=a and y=b (a≠b), respectively, on a same carrier frequency (i.e., serving cell) and the two CSI reports overlap in time, the CSI report with higher Pri_{iCSI} (y, k, c, s) value shall not be sent by the UE. Otherwise if a=b , the two CSI reports are either multiplexed or one of them is dropped based on the priority values, as described in Clause 9.2.5.2 in 3GPP TS 38.213.

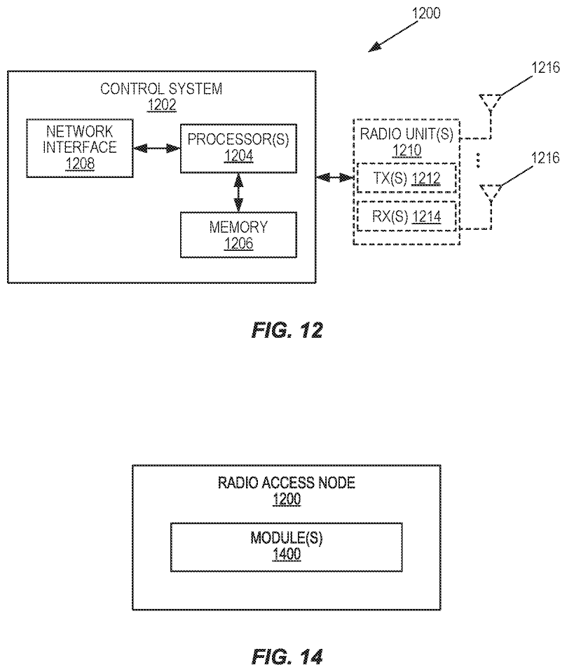

FIG. 12 is a schematic block diagram of a radio access node 1200 according to some embodiments of the present disclosure. Optional features are represented by dashed boxes. The radio access node 1200 may be, for example, a base station 702 or 706 or a network node that implements all or part of the functionality of the base station 702 or gNB described herein. As illustrated, the radio access node 1200 includes a control system 1202 that includes one or more processors 1204 (e.g., Central Processing Units (CPUs), Application Specific Integrated Circuits (ASICs), Field Programmable Gate Arrays (FPGAs), and/or the like), memory 1206, and a network interface 1208. The one or more processors 1204 are also referred to herein as processing circuitry. In addition, the radio access node 1200 may include one or more radio units 1210 that each includes one or more transmitters 1212 and one or more receivers 1214 coupled to one or more antennas 1216. The radio units 1210 may be referred to or be part of radio interface circuitry. In some embodiments, the radio unit(s) 1210 is external to the control system 1202 and connected to the control system 1202 via, e.g., a wired connection (e.g., an optical cable). However, in some other embodiments, the radio unit(s) 1210 and potentially the antenna(s) 1216 are integrated together with the control system 1202. The one or more processors 1204 operate to provide one or more functions of a radio access node 1200 as described herein. In some embodiments, the function(s) are implemented in software that is stored, e.g., in the memory 1206 and executed by the one or more processors 1204.

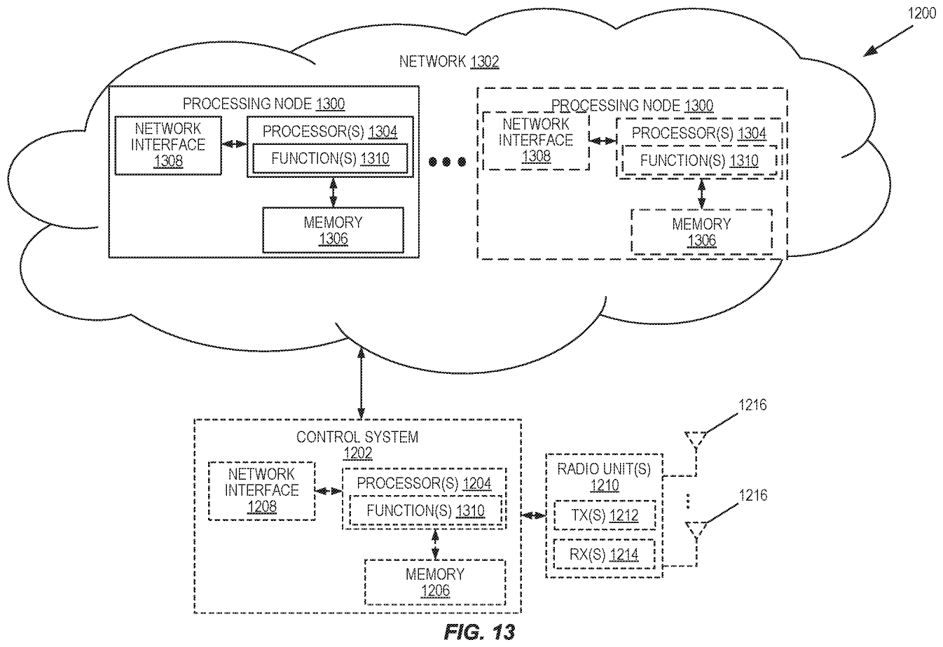

FIG. 13 is a schematic block diagram that illustrates a virtualized embodiment of the radio access node 1200 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1200 in which at least a portion of the functionality of the radio access node 1200 is implemented as a virtual component(s) (e.g., via a virtual machine(s) executing on a physical processing node(s) in a network(s)). As illustrated, in this example, the radio access node 1200 may include the control system 1202 and/or the one or more radio units 1210, as described above. The control system 1202 may be connected to the radio unit(s) 1210 via, for example, an optical cable or the like. The radio access node 1200 includes one or more processing nodes 1300 coupled to or included as part of a network(s) 1302. If present, the control system 1202 or the radio unit(s) are connected to the processing node(s) 1300 via the network 1302. Each processing node 1300 includes one or more processors 1304 (e.g., CPUs, ASICs, FPGAs, and/or the like), memory 1306, and a network interface 1308.

In this example, functions 1310 of the radio access node 1200 described herein are implemented at the one or more processing nodes 1300 or distributed across the one or more processing nodes 1300 and the control system 1202 and/or the radio unit(s) 1210 in any desired manner. In some particular embodiments, some or all of the functions 1310 of the radio access node 1200 described herein are implemented as virtual components executed by one or more virtual machines implemented in a virtual environment(s) hosted by the processing node(s) 1300. As will be appreciated by one of ordinary skill in the art, additional signaling or communication between the processing node(s) 1300 and the control system 1202 is used in order to carry out at least some of the desired functions 1310. Notably, in some embodiments, the control system 1202 may not be included, in which case the radio unit(s) 1210 communicate directly with the processing node(s) 1300 via an appropriate network interface(s).

In some embodiments, a computer program including instructions which, when executed by at least one processor, causes the at least one processor to carry out the functionality of radio access node 1200 or a node (e.g., a processing node 1300) implementing one or more of the functions 1310 of the radio access node 1200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the radio access node 1200 according to some other embodiments of the present disclosure. The radio access node 1200 includes one or more modules 1400, each of which is implemented in software. The module(s) 1400 provide the functionality of the radio access node 1200 described herein. This discussion is equally applicable to the processing node 1300 of FIG. 13 where the modules 1400 may be implemented at one of the processing nodes 1300 or distributed across multiple processing nodes 1300 and/or distributed across the processing node(s) 1300 and the control system 1202.

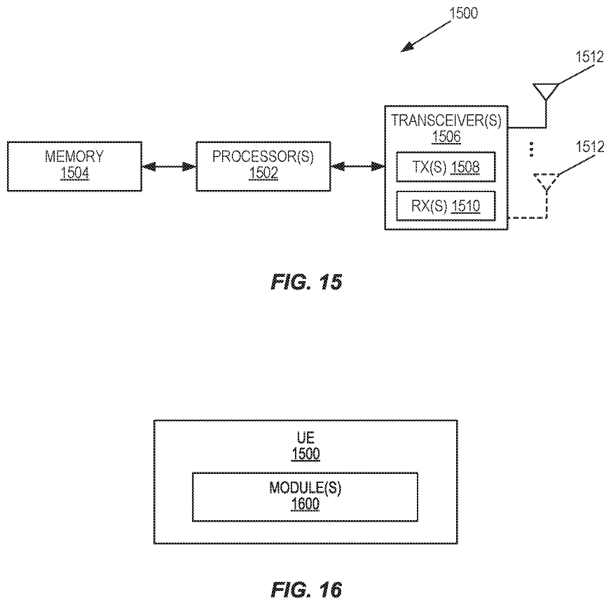

FIG. 15 is a schematic block diagram of a wireless communication device 1500 according to some embodiments of the present disclosure. As illustrated, the wireless communication device 1500 includes one or more processors 1502 (e.g., CPUs, ASICs, FPGAs, and/or the like), memory 1504, and one or more transceivers 1506 each including one or more transmitters 1508 and one or more receivers 1510 coupled to one or more antennas 1512. The transceiver(s) 1506 includes radio-front end circuitry connected to the antenna(s) 1512 that is configured to condition signals communicated between the antenna(s) 1512 and the processor(s) 1502, as will be appreciated by on of ordinary skill in the art. The processors 1502 are also referred to herein as processing circuitry. The transceivers 1506 are also referred to herein as radio circuitry. In some embodiments, the functionality of the wireless communication device 1500 described above may be fully or partially implemented in software that is, e.g., stored in the memory 1504 and executed by the processor(s) 1502. Note that the wireless communication device 1500 may include additional components not illustrated in FIG. 15 such as, e.g., one or more user interface components (e.g., an input/output interface including a display, buttons, a touch screen, a microphone, a speaker(s), and/or the like and/or any other components for allowing input of information into the wireless communication device 1500 and/or allowing output of information from the wireless communication device 1500), a power supply (e.g., a battery and associated power circuitry), etc.

In some embodiments, a computer program including instructions which, when executed by at least one processor, causes the at least one processor to carry out the functionality of the wireless communication device 1500 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the wireless communication device 1500 according to some other embodiments of the present disclosure. The wireless communication device 1500 includes one or more modules 1600, each of which is implemented in software. The module(s) 1600 provide the functionality of the wireless communication device 1500 described herein.

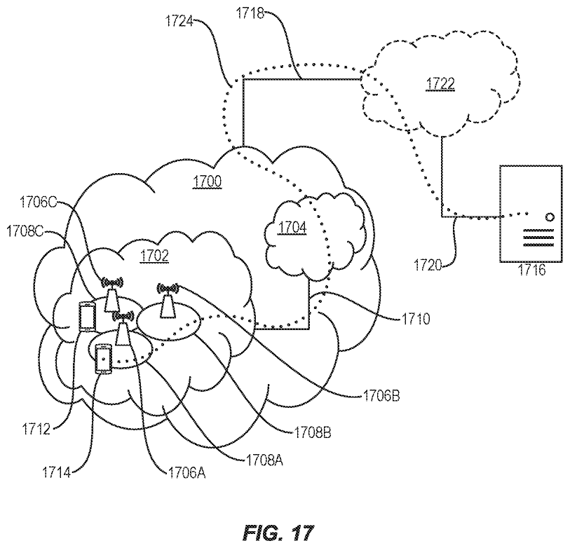

With reference to FIG. 17, in accordance with an embodiment, a communication system includes a telecommunication network 1700, such as a 3GPP-type cellular network, which comprises an access network 1702, such as a RAN, and a core network 1704. The access network 1702 comprises a plurality of base stations 1706A, 1706B, 1706C, such as Node Bs, eNBs, gNBs, or other types of wireless Access Points (APs), each defining a corresponding coverage area 1708A, 1708B, 1708C. Each base station 1706A, 1706B, 1706C is connectable to the core network 1704 over a wired or wireless connection 1710. A first UE 1712 located in coverage area 1708C is configured to wirelessly connect to, or be paged by, the corresponding base station 1706C. A second UE 1714 in coverage area 1708A is wirelessly connectable to the corresponding base station 1706A. While a plurality of UEs 1712, 1714 are illustrated in this example, the disclosed embodiments are equally applicable to a situation where a sole UE is in the coverage area or where a sole UE is connecting to the corresponding base station 1706.

The telecommunication network 1700 is itself connected to a host computer 1716, which may be embodied in the hardware and/or software of a standalone server, a cloud-implemented server, a distributed server, or as processing resources in a server farm. The host computer 1716 may be under the ownership or control of a service provider, or may be operated by the service provider or on behalf of the service provider. Connections 1718 and 1720 between the telecommunication network 1700 and the host computer 1716 may extend directly from the core network 1704 to the host computer 1716 or may go via an optional intermediate network 1722. The intermediate network 1722 may be one of, or a combination of more than one of, a public, private, or hosted network; the intermediate network 1722, if any, may be a backbone network or the Internet; in particular, the intermediate network 1722 may comprise two or more sub-networks (not shown).

The communication system of FIG. 17 as a whole enables connectivity between the connected UEs 1712, 1714 and the host computer 1716. The connectivity may be described as an Over-the-Top (OTT) connection 1724. The host computer 1716 and the connected UEs 1712, 1714 are configured to communicate data and/or signaling via the OTT connection 1724, using the access network 1702, the core network 1704, any intermediate network 1722, and possible further infrastructure (not shown) as intermediaries. The OTT connection 1724 may be transparent in the sense that the participating communication devices through which the OTT connection 1724 passes are unaware of routing of uplink and downlink communications. For example, the base station 1706 may not or need not be informed about the past routing of an incoming downlink communication with data originating from the host computer 1716 to be forwarded (e.g., handed over) to a connected UE 1712. Similarly, the base station 1706 need not be aware of the future routing of an outgoing uplink communication originating from the UE 1712 towards the host computer 1716.

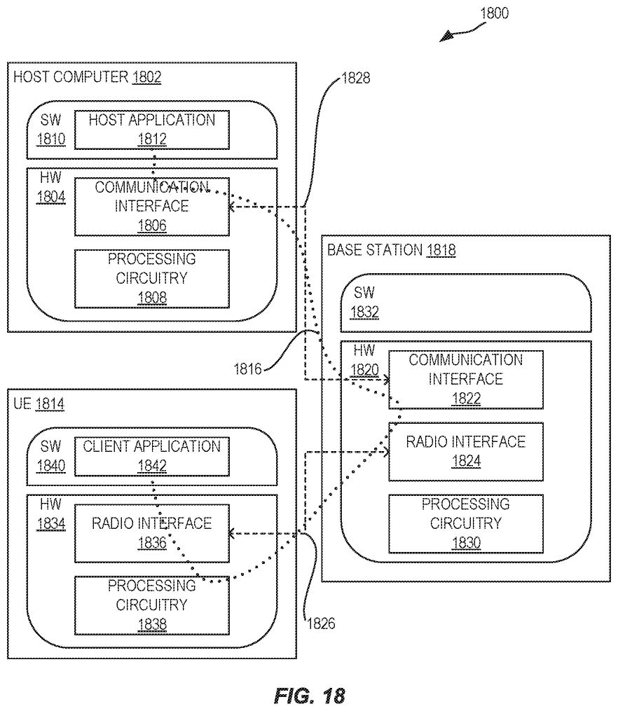

Example implementations, in accordance with an embodiment, of the UE, base station, and host computer discussed in the preceding paragraphs will now be described with reference to FIG. 18. In a communication system 1800, a host computer 1802 comprises hardware 1804 including a communication interface 1806 configured to set up and maintain a wired or wireless connection with an interface of a different communication device of the communication system 1800. The host computer 1802 further comprises processing circuitry 1808, which may have storage and/or processing capabilities. In particular, the processing circuitry 1808 may comprise one or more programmable processors, ASICs, FPGAs, or combinations of these (not shown) adapted to execute instructions. The host computer 1802 further comprises software 1810, which is stored in or accessible by the host computer 1802 and executable by the processing circuitry 1808. The software 1810 includes a host application 1812. The host application 1812 may be operable to provide a service to a remote user, such as a UE 1814 connecting via an OTT connection 1816 terminating at the UE 1814 and the host computer 1802. In providing the service to the remote user, the host application 1812 may provide user data which is transmitted using the OTT connection 1816.

The communication system 1800 further includes a base station 1818 provided in a telecommunication system and comprising hardware 1820 enabling it to communicate with the host computer 1802 and with the UE 1814. The hardware 1820 may include a communication interface 1822 for setting up and maintaining a wired or wireless connection with an interface of a different communication device of the communication system 1800, as well as a radio interface 1824 for setting up and maintaining at least a wireless connection 1826 with the UE 1814 located in a coverage area (not shown in FIG. 18) served by the base station 1818. The communication interface 1822 may be configured to facilitate a connection 1828 to the host computer 1802. The connection 1828 may be direct or it may pass through a core network (not shown in FIG. 18) of the telecommunication system and/or through one or more intermediate networks outside the telecommunication system. In the embodiment shown, the hardware 1820 of the base station 1818 further includes processing circuitry 1830, which may comprise one or more programmable processors, ASICs, FPGAs, or combinations of these (not shown) adapted to execute instructions. The base station 1818 further has software 1832 stored internally or accessible via an external connection.

The communication system 1800 further includes the UE 1814 already referred to. The UE's 1814 hardware 1834 may include a radio interface 1836 configured to set up and maintain a wireless connection 1826 with a base station serving a coverage area in which the UE 1814 is currently located. The hardware 1834 of the UE 1814 further includes processing circuitry 1838, which may comprise one or more programmable processors, ASICs, FPGAs, or combinations of these (not shown) adapted to execute instructions. The UE 1814 further comprises software 1840, which is stored in or accessible by the UE 1814 and executable by the processing circuitry 1838. The software 1840 includes a client application 1842. The client application 1842 may be operable to provide a service to a human or non-human user via the UE 1814, with the support of the host computer 1802. In the host computer 1802, the executing host application 1812 may communicate with the executing client application 1842 via the OTT connection 1816 terminating at the UE 1814 and the host computer 1802. In providing the service to the user, the client application 1842 may receive request data from the host application 1812 and provide user data in response to the request data. The OTT connection 1816 may transfer both the request data and the user data. The client application 1842 may interact with the user to generate the user data that it provides.

It is noted that the host computer 1802, the base station 1818, and the UE 1814 illustrated in FIG. 18 may be similar or identical to the host computer 1716, one of the base stations 1706A, 1706B, 1706C, and one of the UEs 1712, 1714 of FIG. 17, respectively. This is to say, the inner workings of these entities may be as shown in FIG. 18 and independently, the surrounding network topology may be that of FIG. 17.

In FIG. 18, the OTT connection 1816 has been drawn abstractly to illustrate the communication between the host computer 1802 and the UE 1814 via the base station 1818 without explicit reference to any intermediary devices and the precise routing of messages via these devices. The network infrastructure may determine the routing, which may be configured to hide from the UE 1814 or from the service provider operating the host computer 1802, or both. While the OTT connection 1816 is active, the network infrastructure may further take decisions by which it dynamically changes the routing (e.g., on the basis of load balancing consideration or reconfiguration of the network).

The wireless connection 1826 between the UE 1814 and the base station 1818 is in accordance with the teachings of the embodiments described throughout this disclosure. One or more of the various embodiments improve the performance of OTT services provided to the UE 1814 using the OTT connection 1816, in which the wireless connection 1826 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve.

There may further be an optional network functionality for reconfiguring the OTT connection 1816 between the host computer 1802 and the UE 1814, in response to variations in the measurement results. The measurement procedure and/or the network functionality for reconfiguring the OTT connection 1816 may be implemented in the software 1810 and the hardware 1804 of the host computer 1802 or in the software 1840 and the hardware 1834 of the UE 1814, or both. In some embodiments, sensors (not shown) may be deployed in or in association with communication devices through which the OTT connection 1816 passes; the sensors may participate in the measurement procedure by supplying values of the monitored quantities exemplified above, or supplying values of other physical quantities from which the software 1810, 1840 may compute or estimate the monitored quantities. The reconfiguring of the OTT connection 1816 may include message format, retransmission settings, preferred routing, etc.; the reconfiguring need not affect the base station 1818, and it may be unknown or imperceptible to the base station 1818. Such procedures and functionalities may be known and practiced in the art. In certain embodiments, measurements may involve proprietary UE signaling facilitating the host computer's 1802 measurements of throughput, propagation times, latency, and the like. The measurements may be implemented in that the software 1810 and 1840 causes messages to be transmitted, in particular empty or ‘dummy’ messages, using the OTT connection 1816 while it monitors propagation times, errors, etc.

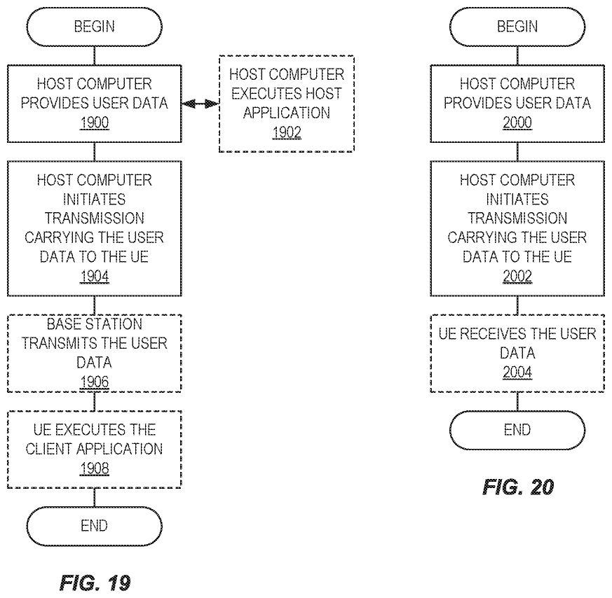

FIG. 19 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 19 will be included in this section. In step 1900, the host computer provides user data. In sub-step 1902 (which may be optional) of step 1900, the host computer provides the user data by executing a host application. In step 1904, the host computer initiates a transmission carrying the user data to the UE. In step 1906 (which may be optional), the base station transmits to the UE the user data which was carried in the transmission that the host computer initiated, in accordance with the teachings of the embodiments described throughout this disclosure. In step 1908 (which may also be optional), the UE executes a client application associated with the host application executed by the host computer.

FIG. 20 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 20 will be included in this section. In step 2000 of the method, the host computer provides user data. In an optional sub-step (not shown) the host computer provides the user data by executing a host application. In step 2002, the host computer initiates a transmission carrying the user data to the UE. The transmission may pass via the base station, in accordance with the teachings of the embodiments described throughout this disclosure. In step 2004 (which may be optional), the UE receives the user data carried in the transmission.

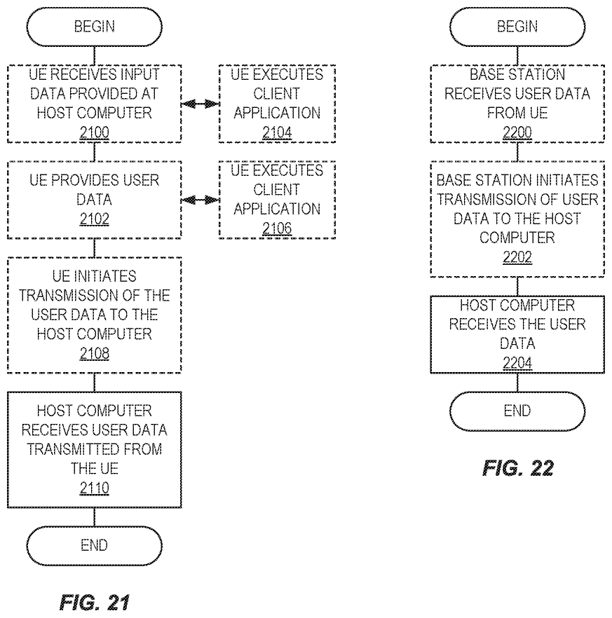

FIG. 21 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 21 will be included in this section. In step 2100 (which may be optional), the UE receives input data provided by the host computer. Additionally or alternatively, in step 2102, the UE provides user data. In sub-step 2104 (which may be optional) of step 2100, the UE provides the user data by executing a client application. In sub-step 2106 (which may be optional) of step 2102, the UE executes a client application which provides the user data in reaction to the received input data provided by the host computer. In providing the user data, the executed client application may further consider user input received from the user. Regardless of the specific manner in which the user data was provided, the UE initiates, in sub-step 2108 (which may be optional), transmission of the user data to the host computer. In step 2110 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 22 will be included in this section. In step 2200 (which may be optional), in accordance with the teachings of the embodiments described throughout this disclosure, the base station receives user data from the UE. In step 2202 (which may be optional), the base station initiates transmission of the received user data to the host computer. In step 2204 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ACK Acknowledgement
A-CSI Aperiodic Channel State Information
AF Application Function
AMF Access and Mobility Function
AN Access Network
AP Access Point
ASIC Application Specific Integrated Circuit
AUSF Authentication Server Function
BWP Bandwidth Part
CA Carrier Aggregation
CBG Code Block Group
CP-OFDM Cyclic Prefix Orthogonal Frequency Division Multiplexing
CPU Central Processing Unit
CQI Channel Quality Indication
CRC Cyclic Redundancy Check
CRI CSI-RS Resource Indicator
CSI Channel State Information
CSI-IM Channel-State Information Interference Measurement
CSI-RS Channel-State Information Reference Signal
CW Codeword
DCI Downlink Control Information
DFT-S-OFDM Discrete Fourier Transform Spread OFDM
DL Downlink
DN
DSP
eNB
FH
FPGA
gNB
gNB-DU
HARQ
HSS
Data Network
Digital Signal Processor
Enhanced or Evolved Node B
Frequency Hopping
Field Programmable Gate Array
New Radio Base Station
New Radio Base Station Distributed Unit
Hybrid Automatic Repeat Request
Home Subscriber Server
IoT Internet of Things
IP Internet Protocol
LTE Long Term Evolution
MIMO Multiple Input Multiple Output
MME Mobility Management Entity
MTC Machine Type Communication
NEF Network Exposure Function
NF Network Function
NR New Radio
NRF Network Function Repository Function
NSSF Network Slice Selection Function
NZP Non-Zero Power
OTT Over-the-Top
PC Personal Computer
PCF Policy Control Function
PDCCH Physical Downlink Control Channel
PDSCH Physical Downlink Shared Channel
P-GW Packet Data Network Gateway
PMI Precoding Matrix Indicator
PUCCH Physical Uplink Control Channel
PUSCH Physical Uplink Shared Channel
RAM Random Access Memory
RAN Radio Access Network
RB Resource Block
RE Resource Element
RI Rank Indicator
ROM Read Only Memory
RRC Radio Resource Control
RRH Remote Radio Head
RSRP Reference Signal Received Power
RTT Round Trip Time
SCEF Service Capability Exposure Function
SINR Signal to Interference Plus Noise Ratio
SMF
SR
SSB
TB
TCI
TRP
UCI
UDM
UE
Session Management Function
Scheduling Request
Synchronization Signal Block
Transport Block
Transmission Configuration Indicator
Transmission/Reception Point
Uplink Channel Information
Unified Data Management
User Equipment
UPF User Plane Function
URLLC Ultra Reliable Low Latency Communication

Those skilled in the art will recognize improvements and modifications to the embodiments of the present disclosure. All such improvements and modifications are considered within the scope of the concepts disclosed herein.

1. A method performed by a wireless device for priority level handling, the method comprising:
determining a first priority level of a first Uplink Control Information, UCI, where the first UCI is an aperiodic Channel State Information, CSI, on Physical Uplink Control Channel, PUCCH, triggered by a downlink related Downlink Control Information, DCI;
determining a second priority level of a second UCI; and
performing a priority level handling action based on a comparison of the first priority level and the second priority level.

2. The method of claim 1 wherein the second UCI comprises one or more of the group consisting of:
one or more Hybrid Automatic Repeat Request, HARQ, Acknowledgement/Negative Acknowledgements, ACK/NACKs;
a Scheduling Request, SR;
an aperiodic CSI report to be carried on Physical Uplink Shared Channel, PUSCH;
a semi-persistent CSI report to be carried on the PUCCH;
a periodic CSI report to be carried on the PUCCH; and
a second aperiodic CSI report to be carried on the PUCCH.

3. The method of claim 1, wherein performing the priority level handling action comprises one or more of the group consisting of:
multiplexing the first UCI and the second UCI and transmitting them together in one uplink resource;
transmitting the first UCI and the second UCI separately in different uplink resources; and
dropping one of the first UCI or the second UCI and transmitting only one of the UCIs in the one uplink resource.

4. The method of claim 3 where the one uplink resource is a PUCCH resource.

5. The method of claim 3 where the one uplink resource is an allocated PUSCH resource.

6. The method of claim 1, wherein the first priority level is determined by a priority indicator field in the downlink related Downlink Control Information, DCI, if the priority indicator field is configured to be present in the downlink related DCI.

7. The method of claim 1, wherein the first priority level is determined to be a default priority level if the priority indicator field is not configured to be present in the downlink related DCI.

8. The method of claim 1, wherein the first priority level is assigned a fixed priority level.

9. The method of claim 1, wherein the second priority level is determined by one or more of the group consisting of:
a priority indicator field in a DCI which is the same as the downlink related DCI;
a priority indicator field in a DCI which is different from the downlink related DCI;
a default value if a priority indicator field is not configured in a DCI; and
a fixed priority level.

10. The method of claim 1, wherein when the first UCI and the second UCI overlap in a time domain, the first UCI and the second UCI are multiplexed and transmitted in the PUCCH resource or the allocated PUSCH resource if the first priority level is the same as the second priority level.

11. The method of claim 1, wherein when the first UCI and the second UCI overlap in a time domain, the first UCI and the second UCI are multiplexed and transmitted in the PUCCH resource or the allocated PUSCH resource even if the first priority level is different from the second priority level.

12. The method of claim 3, wherein the multiplexing and transmission of the first and second UCIs is on all N repetitions when the PUCCH resource or the allocated PUSCH resource is indicated to be repeated N times.

13. The method of claim 3, wherein the multiplexing and transmission of the first and second UCIs is on a subset of N repetitions when the PUCCH resource or the allocated PUSCH resource is indicated to be repeated N times.

14. The method of claim 1, wherein when the first UCI and the second UCI overlap in the time domain, the UCI with a higher priority level is transmitted in the PUCCH resource or the allocated PUSCH resource while the UCI with a lower priority level is dropped.

15. A method performed by a base station for priority level handling, the method comprising:
determining a first priority level of a first Uplink Control Information, UCI, where the first UCI is an aperiodic Channel State Information, CSI, on Physical Uplink Control Channel, PUCCH, triggered by a downlink related Downlink Control Information, DCI;
determining a second priority level of a second UCI; and
performing a priority level handling action based on a comparison of the first priority level and the second priority level.

16. The method of claim 15 wherein the second UCI comprises one or more of the group consisting of:
one or more Hybrid Automatic Repeat Request, HARQ, Acknowledgement/Negative Acknowledgements, ACK/NACKs;
a Scheduling Request, SR;
an aperiodic CSI report to be carried on Physical Uplink Shared Channel, PUSCH;
a semi-persistent CSI report to be carried on the PUCCH;
a periodic CSI report to be carried on the PUCCH; and
a second aperiodic CSI report to be carried on the PUCCH.

17. The method of claim 15, wherein performing the priority level handling action comprises one or more of the group consisting of:
multiplexing the first UCI and the second UCI and transmitting them together in one uplink resource;
transmitting the first UCI and the second UCI separately in different uplink resources; and
dropping one of the first UCI or the second UCI and transmitting only one of the UCIs in the one uplink resource.

18. The method of claim 17 where the one uplink resource is a PUCCH resource.

19-28. (canceled)

29. A wireless device for priority level handling, the wireless device comprising:
one or more processors; and
memory storing instructions executable by the one or more processors, whereby the wireless device is operable to perform:
determine a first priority level of a first Uplink Control Information, UCI, where the first UCI is an aperiodic Channel State Information, CSI, on Physical Uplink Control Channel, PUCCH, triggered by a downlink related Downlink Control Information, DCI;
determine a second priority level of a second UCI; and
perform a priority level handling action based on a comparison of the first priority level and the second priority level.

30. (canceled)

31. A base station for priority level handling, the base station comprising:
one or more processors; and
memory comprising instructions to cause the base station to perform:
determine a first priority level of a first Uplink Control Information, UCI, where the first UCI is an aperiodic Channel State Information, CSI, on Physical Uplink Control Channel, PUCCH, triggered by a downlink related Downlink Control Information, DCI;
determine a second priority level of a second UCI; and
perform a priority level handling action based on a comparison of the first priority level and the second priority level.

32. (canceled)
